(19) United States
(12) Patent Application Publication
(10) Pub. No.: US 2022/0148152 A1
(43) Pub. Date: May 12, 2022

(54) SYSTEM AND METHOD FOR ADJUSTABLE PRODUCTION LINE INSPECTION

(71) Applicant: INSPEKTO A.M.V. LTD., RAMAT GAN (IL)

(72) Inventors: YONATAN HYATT, TEL-AVIV (IL); HAREL BOREN, GIVAT SHMUEL (IL)

(21) Appl. No.: 17/436,083

(22) PCT Filed: Mar. 1, 2020
(86) PCT No.: PCT/IL2020/050233

§ 371 Date: Sep. 3, 2021

Related U.S. Application Data
(60) Provisional application No. 62/813,253, filed on Mar. 4, 2019.

(30) Foreign Application Priority Data
Mar. 4, 2019 (IL) 265163

(51) Int. Cl. G06T 7/00; G06T 7/38; G06T 7/70; G06T 7/11; G06T 7/246; G06V 10/25

(52) U.S. Cl. CPC G06T 7/0004; G06T 7/38; G06V 10/25; G06T 7/11; G06T 7/246; G06T 7/70

(57) ABSTRACT

A visual inspection system and method include receiving input from a camera, including an image of an item on an inspection line, and based on the input, calculating, an expected performance of the system. The expected performance may be displayed to a user. An adjusted expected performance can be calculated based on adjusted parameters of the system, input by the user and the adjusted expected performance may be displayed to the user.

### FIELD

The present invention relates to visual inspection processes, for example, image based inspection of items on a production line.

### BACKGROUND

Inspection during production processes helps control the quality of products by identifying defects and acting upon their detection, for example, by fixing them or discarding defected parts, and is thus useful in improving productivity, reducing defect rates, and reducing re-work and waste.

Automated visual inspection methods are used in production lines to identify visually detectable anomalies that may have a functional or esthetical impact on the integrity of a manufactured part. Existing visual inspection solutions for production lines on the market today rely on custom made automated visual inspection systems, which are typically highly expensive and require expert integration of hardware and software components, as well as expert maintenance of these in the life-time of the inspection solution and the production line.

In addition to the initial high cost of the system, each new manufactured article or new identified defect causes downtime that may be measured in months, between the time a project is initiated until it is deployed. In the interim period, a plant is compelled to use expensive internal/external human workforce to perform quality assurance (QA), gating, sorting or other tasks, or bear the risk and/or production degrade of not performing any of these at one or more parts of the plant production lines.

There is a growing inconsistency between industrial plants' need for agility and improvement, on one hand, and the cumbersome and expensive set up process of contemporary inspection solutions, on the other hand.

### SUMMARY

Embodiments of the invention provide an adjustable image-based inspection system and process in which a user is informed, prior to beginning the inspection stage, of expected inspection performance in relation to an inspected item. The user (who may be, for example, a plant's inspection line manager) may then adjust parameters of the inspection system and/or of the inspected item to change (typically, improve) the expected performance.

Prior information regarding inspection performance reduces user frustration and can enable the user to improve or adapt the performance to the user or plant's needs, in real-time.

Inspection performance, which typically means the quality of defect detection and/or other inspection tasks (such as, defect detection, quality assurance (QA), sorting and/or counting, gating, etc.), may be determined by parameters that affect inspection results. For example, the minimal size of a detectable defect may be a parameter that affects the inspection results. Namely, defects that are below the minimal size of a detectable defect may not be detected.

In another example, the time to detection is a parameter that affects the inspection results. Namely, the time to detection, which includes the period of time between receiving the image of the item and detecting a defect on the item and possibly outputting defect information to a user, per one item, affects the overall inspection time per batch or inspection process of a known number of items.

In one embodiment, a visual inspection system includes a processor in communication with a user interface and a camera. The processor receives from the camera input, which includes an image of an item on an inspection line. Based on the input, the processor calculates an expected performance of the system and outputs, via the user interface, the expected performance.

In one embodiment, the processor receives an image of an item on an inspection line and calculates a minimal detectable defect size, typically in size units such as metric or imperial units, based on the distance of the camera from the item. The minimal detectable defect size may be output to the user, e.g., via the user interface, such that the user is aware of the minimal detectable defect size, and may include in the inspection process only items with expected defect sizes that are above the minimal detectable size. Alternatively, the user may adjust the distance of the item from the camera and/or change the zoom level, to reduce or increase the detectable defect size.

In another embodiment the processor receives an image of an item on an inspection line and determines (or estimates) a time to detection based on the image. For example, the time to detection may be determined based on inspection parameters, as further described herein. Adjustment of the inspection parameters may increase or decrease the time to detection. The determined time to detection may be output to the user, e.g., via the user interface, such that the user is aware of the expected duration of the process and may adjust parameters to change the time to detection and/or plan processes more efficiently.

### BRIEF DESCRIPTION OF THE DRAWINGS

The invention will now be described in relation to certain examples and embodiments with reference to the following illustrative drawing figures so that it may be more fully understood. In the drawings:

FIG. 1 schematically illustrates a system for production line inspection, operable according to embodiments of the invention;

FIG. 2 schematically illustrates a method for visual inspection which includes calculating a minimal detectable defect size, according to one embodiment of the invention;

FIGS. 3A and B schematically illustrate a method for visual inspection which includes presenting the minimal detectable defect size to a user, according to embodiments of the invention;

FIG. 4 schematically illustrates a method for visual inspection based on a plurality of images, according to embodiments of the invention;

FIG. 5 schematically illustrates a method for visual inspection which includes determining a plurality of minimal detectable defect sizes for different regions of the item, according to embodiments of the invention;

FIGS. 6A and B schematically illustrate a method for visual inspection which includes determining time to detection, according to an embodiment of the invention;

FIG. 7 schematically illustrates a method for visual inspection which includes determining time to detection based on detected motion, according to one embodiment of the invention; and

FIG. 8 schematically illustrates a method for visual inspection, which includes determining time to detection based on a plurality of images, according to an embodiment of the invention.

### DETAILED DESCRIPTION

Embodiments of the invention provide inspection processes or tasks, such as, defect detection, sorting and/or counting. These tasks, especially defect detection, are important for quality assurance (QA), gating and sorting on production lines, and are consequently useful in improving productivity, production processes and working procedures, reducing defect rates, and reducing re-work and waste.

The term ‘defect’ may include, for example, a visible flaw on the surface of an item, an undesirable size, shape or color of the item or of parts of the item, an undesirable number of parts of the item, a wrong or missing assembly of its interfaces, a broken or burned part, an incorrect alignment of an item or parts of an item, a wrong or defected barcode, and in general, any difference between a defect free sample and the inspected item, which would be evident from the images to a user, namely, a human inspector in the production line. In some embodiments, a defect may include flaws which are visible only in enlarged or high resolution images, e.g., images obtained by microscopes or other specialized cameras.

Inspection processes, according to embodiments of the invention, typically include a set up stage prior to an inspection stage.

In one embodiment, in the set up stage, samples of a manufactured item possibly with no defects (defect-free items) are imaged on an inspection line. These images (also termed ‘set up images’) are analyzed by a processor and are then used as reference images for machine learning algorithms run at the inspection stage.

In the inspection stage, inspected items (manufactured items that are to be inspected for defects) are imaged and the image data collected from each inspected item is analyzed by computer vision algorithms such as machine learning processes, to detect one or more defects on each inspected item.

Once a defect is detected on an inspected item, defect information, such as indication of a defect, the location of the defect, its size, etc., may be output to the user.

In the set up stage, a processor learns parameters of images of defect-free items, for example, imaging parameters (e.g., exposure time, focus and illumination), spatial properties and uniquely representing features of a defect-free item in images. These parameters may be learned, for example, by analyzing images of a defect-free item using different imaging parameters and by analyzing the relation between different images of a same type of defect-free item. Registration of set up images may be analyzed to find optimal parameters to enable the best alignment between the images and to detect an external boundary of the item.

This analysis, using different imaging parameters and comparing several images of defect-free items during the set up stage, enables to discriminatively detect a same type of item (either defect-free or with a defect) in a new image (e.g., a new image obtained in the inspection stage following the set up stage), regardless of the imaging environment of the new image.

Although a particular example of a setup and inspection stage of a visual inspection process is described herein, it should be appreciated that embodiments of the invention may be practiced with other setup and inspection procedures of visual inspection processes.

The term “same-type items” or the like, refers to items or objects which are of the same physical makeup and are similar to each other in shape and dimensions and possibly color and other physical features. Typically, items of a single production series, batch of same-type items or batch of items in the same stage in its production line, may be “same-type items”. For example, if the inspected items are sanitary products, different sink bowls of the same batch are same-type items. Same type items may differ from each other within permitted tolerances.

In embodiments of the invention information obtained during the setup stage can be used to calculate (or, possibly, estimate) inspection performance expected in the following inspection stage. A user (e.g., a plant's inspection line manager or operator) may be advised of the expected inspection performance prior to commencement of the inspection stage, so that the user can plan and/or adjust the inspection system accordingly.

In one embodiment, a visual inspection process includes receiving at a processor input from a camera, input which includes an image of an item on an inspection line. In a set up stage of the inspection process, which is followed by an inspection stage, an expected performance of the system during the inspection stage is calculated, based on the input. The expected performance is then output to a user, typically prior to the inspection stage.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying”, “learning” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

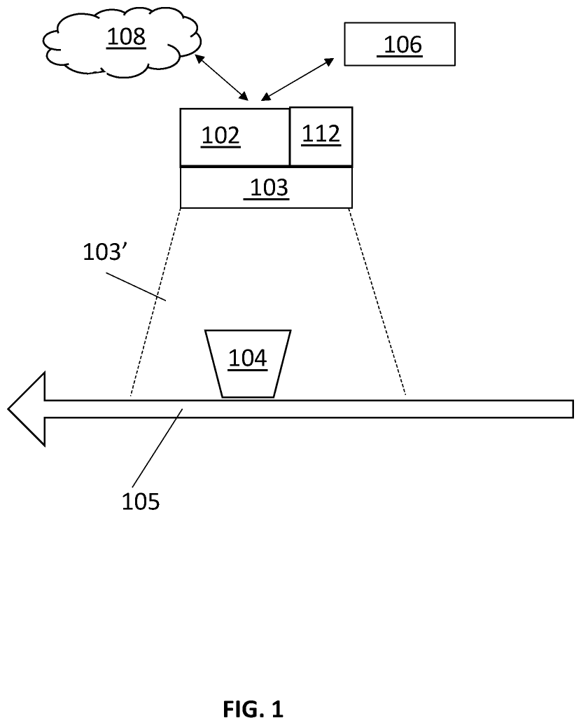

An exemplary system, which may be used for image-based inspection processes according to embodiments of the invention, is schematically illustrated in FIG. 1. In one embodiment, the system includes a processor 102 in communication with one or more camera(s) 103 and with a device, such as a user interface device 106 and/or other devices, such as storage device 108.

Components of the system may be in wired or wireless communication and may include suitable ports and/or network hubs. In some embodiments processor 102 may communicate with a device, such as storage device 108 and/or user interface device 106 via a controller, such as a programmable logic controller (PLC), typically used in manufacturing processes, e.g., for data handling, storage, processing power, and communication capabilities. A controller may be in communication with processor 102, storage device 108, user interface device 106 and/or other components of the system, via USB, Ethernet, appropriate cabling, etc.

Processor 102 may include, for example, one or more processors and may be a central processing unit (CPU), a graphics processing unit (GPU), a digital signal processor (DSP), a field-programmable gate array (FPGA), a microprocessor, a controller, a chip, a microchip, an integrated circuit (IC), or any other suitable multi-purpose or specific processor or controller. Processor 102 may be locally embedded or remote.

The user interface device 106 may include a display, such as a monitor or screen, for displaying images, instructions and/or notifications to a user (e.g., via text or other content displayed on the monitor). User interface device 106 may also be designed to receive input from a user. For example, user interface device 106 may include a monitor and keyboard and/or mouse and/or touch screen, to enable user input.

Storage device 108 may be a server including for example, volatile and/or non-volatile storage media, such as a hard disk drive (HDD) or solid-state drive (SSD). Storage device 108 may be connected locally or remotely, e.g., in the cloud. In some embodiments, storage device 108 may include software to receive and manage image data related to set up images and images of inspected items. For example, databases and look-up-tables may be maintained and managed in storage device 108.

Camera(s) 103, which are configured to obtain an image of an inspection line 105, are typically placed and fixed in relation to the inspection line 105 (e.g., a conveyer belt), such that items (e.g., item 104) placed on the inspection line 105 are within the FOV 103′ of the camera 103.

In some embodiments camera 103 may be placed and fixed in relation to the inspection line 105 using a mount, which includes multiple adjustable segments joined together at rotating joints. The mount can be attached to any aluminum profile available on the production line or to any other surface. Thus, motion of a conveyor belt, for example, or other parts of the inspection line, can translate, via the mount, to movement or vibrations of the camera. The mount and/or camera may be provided with stabilizers for vibration damping however, some movement of the camera may occur.

Camera 103 may include a CCD or CMOS or other appropriate image sensor. The camera 103 may be a 2D or 3D camera. In some embodiments, the camera 103 may include a standard camera provided, for example, with mobile devices such as smart-phones or tablets. In other embodiments, the camera 103 is a specialized camera, e.g., a camera for obtaining high resolution images. In other embodiments camera 103 includes a non-optical camera, such as a neutron camera, a RADAR camera and the like.

The system may also include a light source, such as an LED or other appropriate light source, to illuminate the camera FOV 103′, e.g., to illuminate item 104 on the inspection line 105.

Processor 102 receives image data (which may include data such as pixel values that represent the intensity of reflected light as well as partial or full images or videos) of items on the inspection line 105 from the one or more camera(s) 103 and runs processes according to embodiments of the invention.

Processes according to embodiments of the invention include applying detection algorithms, which typically include a sequence of automatically performed steps that are designed to detect objects on an inspection line from images and classify the objects based on requirements of the inspection process. For example, a requirement of an inspection process may be to detect defects on the object and/or perform other inspection tasks, such as QA, sorting and/or counting, gating, etc. Detection algorithms, according to embodiments of the invention, typically include using computer vision techniques.

In some embodiments a desired level of zoom of the camera 103 can be obtained by changing the optical zoom (e.g., lens zoom), or, digitally, for example, by changing the cropped area of the image on which processor 102 runs detection algorithms and which is visible to the user. For example, the image outputted from the camera 103 sensor may be a 20 Mega pixels image, and the image on which processor 102 runs detection algorithms and which is visible to the user is a 5 Mega pixels image. If the 5 Mega pixels image is a resized version of the full 20 Mega pixels image, then no digital zoom is in effect. If the 5 Mega pixels image is a resized version of a 10 Mega pixels sub-image which is part of the original 20 Mega pixels image, then a zoom effect is achieved. If the 5 Mega pixels image is a copied version of a 5 Mega pixels sub-image of the original 20 Mega pixels image, then the maximal zoom possible in this setup is in effect.

Processor 102 is typically in communication with a memory unit 112. Memory unit 112 may store at least part of the image data received from camera(s) 103.

Memory unit 112 may include, for example, a random access memory (RANI), a dynamic RANI (DRAM), a flash memory, a volatile memory, a non-volatile memory, a cache memory, a buffer, a short term memory unit, a long term memory unit, or other suitable memory units or storage units.

In some embodiments the memory unit 112 stores executable instructions that, when executed by processor 102, facilitate performance of operations of processor 102, as described herein.

In one embodiment processor 102 receives a plurality of set up images of an item and applies computer vision and image processing techniques and algorithms to analyze the images (e.g., as described above). Processor 102 then calculates the expected inspection performance of the system for the item and outputs the expected inspection performance, e.g., via user interface device 106.

Inspection performance, which typically means the quality of an inspection task, e.g., the quality of defect detection, may be determined by parameters that affect inspection results.

In one embodiment, a parameter that affects inspection results is the minimal size of a detectable defect.

The amount of pixels, which represents a minimal detectable size of the system, typically depends on parameters of the system such as the number of pixels in the camera 103 sensor, the strength or type of the processor being used to analyze the images, etc. The minimal detectable size (in amount of pixels) is known, per system, and can be input to processor 102. This minimal detectable size of the system may be presented as a line, box, blob, circle or any other shape on an image being presented to a user via user interface device 106. This presentation gives the user a visual indication of an initial expected minimal size of defect detectable by the system. A minimal detectable defect size (which may be the initial expected minimal detectable size of the system or an updated size) can also be calculated and presented to the user in non-pixel units, such as size units, e.g., metric and/or imperial units.

In some embodiments, processor 102 may calculate the minimal detectable defect size for an item based on an optimal focus setting of the camera 103 obtained for the item 104. For each camera, using the zoom level and the focus setting, it is possible to directly calculate a distance of the camera from the item. Alternatively, or in addition, the processer 102 may request an input from the user of the system, regarding the distance of the camera from the item.

In some embodiments, the processor may determine a distance of the camera from the item based on the image of the item and determine the minimal detectable defect size based on the distance of the camera from the item.

Using the distance of the item from the camera, the system can use a database or look-up-table of value, showing the probable minimal detectable defect size for the determined distance of camera, and so determine a value of the minimal detectable defect size.

In some embodiments, the processor may determine the minimal detectable defect size based on a noise level calculated from a plurality of images of an item on an inspection line. Thus, in some embodiments, a user may be provided with an updated value of the minimal detectable defect size after an initial setup image, when enough images of the item have been gathered to determine the noise level of the specific item. For example, an item which is fully repetitive and shows no (or little) difference between two samples of the item, will have a minimal detectable defect size which is even smaller than the probable minimal detectable defect size for the distance of the camera from the item. An item with very high tolerances and differences between two samples of the item will have a minimal detectable defect size which is larger than the probable minimal detectable defect size for the distance of the camera from the item. This updated information can be indicated to the user.

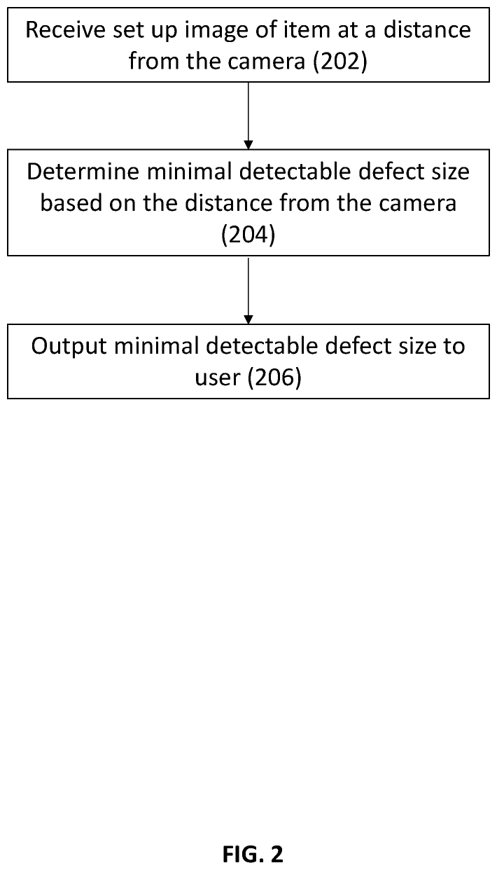

In one example, which is schematically illustrated in FIG. 2, processor 102 may receive an image of an item on an inspection line (202), typically a set up image, e.g., from camera 103. Processor 102 may then calculate a minimal detectable defect size based on a distance of the camera from the item (204). The minimal detectable defect size may then be output to a user (206), e.g., via user interface device 106.

The minimal detectable defect size may be an average or other statistical calculation of data (e.g., previously calculated sizes), based for example, on typical industry produced items tested in labs or in production lines for the minimal detectable defect size and stored for future usage.

In one embodiment, an initial minimal detectable defect size is initially output to the user. In addition, a message may be output (e.g., via the user interface 106), the message relating to a zoom level of the camera. For example, the message may include information on how to change the zoom level and/or distance of camera from the item, in order to change the minimal detectable defect size. The user may then adjust the distance of the camera from the item (which may be done, for example, by physically changing the location of the camera relative to the item, by changing the optical zoom or electronically, e.g., by digitally changing the zoom level of the camera) and thus cause an adjusted size to be calculated and provided to the user. Thus, a user may adjust an initial minimal detectable defect size by adjusting the distance of the camera from the item and may see, in real-time, how his adjustment of the distance of the camera, affects the minimal size.

Calculating a minimal detectable defect size may be done, for example, by pre-calculating the iFOV of the camera, which is the measure in Radians of the angle covered by each pixel of the camera sensor. Using the distance of the camera to the item, the physical size sampled by each pixel of the camera sensor can be measured, and the minimal detectable defect size for the camera can thus be translated to an actual physical size.

In some embodiments, processor 102 may request from the user input regarding the distance of the camera from the item. The distance of the camera from the item may be input by a user (e.g., the distance may be input by a user via user interface device 106), such that the processor receives the distance from the user.

In other embodiments, the processor may receive the distance from another processor or device. For example, the distance of an item from the camera may be calculated by processor 102 or by another processor based on image analysis. For example, the size and/or location of the item (or other objects of known sizes) in the image may be used to calculate the distance of the camera from the item. Alternatively, or in addition, a dedicated range sensor (e.g., using laser, IR or other appropriate methods for measuring distance) may be used to determine the distance of the camera from the item.

In one embodiment, the processor 102 may determine the optimal focus for the item (e.g., based on the camera optics and zoom being used) and calculate the distance of the camera from the object based on the optimal focus, and using pre-performed calibration of the camera determining the exact distance for each focus level.

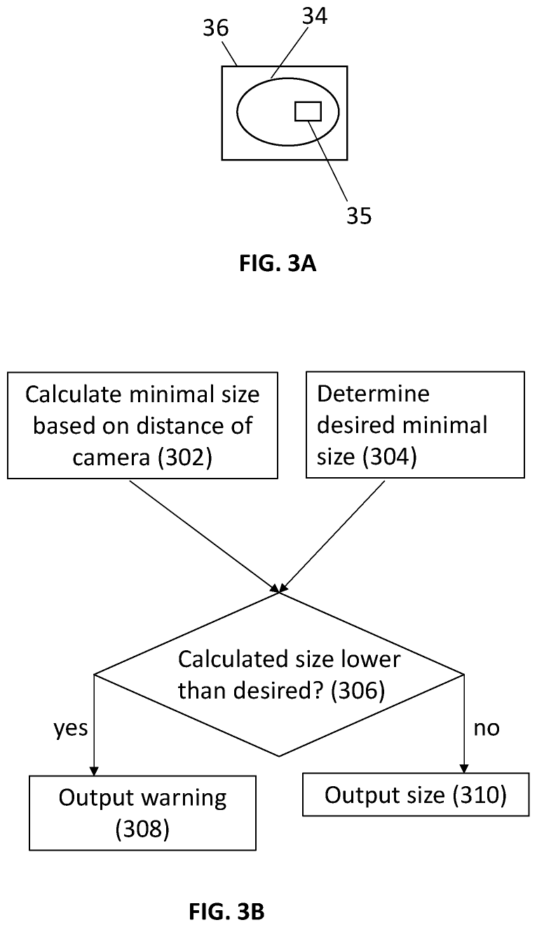

In one embodiment, which is schematically illustrated in FIG. 3A, an initial minimal detectable defect size 35 is displayed to a user as a shape (e.g., line, box, blob, circle, etc.) whose size correlates to the number of pixels representing the minimal detectable size of the system. In one example, the minimal detectable defect size 35 is superimposed on an image 36 of the item 34 that is displayed via user interface device 106. Once a size in non-pixel units is calculated (e.g., as described above), the minimal detectable defect size 35 can be displayed to the user in non-pixel units, such as metric (or other size units) values.

Thus, minimal detectable defect size 35 may include, for example, a line of pixels or box (several lines of pixels) initially and may then be changed to include the size written out in centimeters or millimeters, for example.

In one embodiment, an acceptable minimal detectable size, may be input by a user, e.g., via user interface device 106. For example, a user may input an acceptable size in centimeters (or other size unit) and processor 102 will translate the input size to pixels and then to the advisable distance of item from the camera and/or zoom level of the camera, to obtain the size input by the user. In other embodiments, a user may input an acceptable size by indicating on an image of the item an acceptable minimal size in pixels of the image.

In some embodiments, an acceptable minimal detectable size in pixels or non-pixel units, may be calculated from a database of a plurality of previously obtained acceptable sizes. An acceptable size may be calculated, for example, as a percentage of previously input or calculated acceptable defect sizes for similar defects on same-type or similar items. For example, a size that is no less than 85% of the average of previously input or calculated sizes may be used as a default acceptable size by the system.

As schematically illustrated in FIG. 3B, a minimal detectable defect size in non-pixel units is calculated based on the initial expected minimal detectable size of the system and based on a distance of the camera from the item (302). The desired minimal detectable defect size is determined (304), e.g., based on input from a user or based on calculations, as described above. Using the inputs from steps 302 and 304, it can be determined if, based on the current distance of the camera from the item, the determined minimal detectable size is lower than the desired size (306). If so, the system may output a warning to the user, e.g., to adjust (increase or decrease) the distance of the camera from the item (308). Alternatively or in addition, the system may output the minimal detectable size, e.g., in size units such as centimeter or in pixels (310).

One of the main concerns during the initial steps of the set up stage, while the user is choosing the zoom level for the inspection stage, is the detectable defect size. The embodiments described above provide an improved system and method, which enable presenting to the user at least an expected detectable defect size during these first steps, and allow (and possibly instruct) the user to adjust the zoom level (and/or distance of the camera from the item) to improve the detectable defect size, if necessary.

During further steps of the set up stage additional set up images are collected and further analysis is performed on the additional images, based upon which the minimal defect size may be updated.

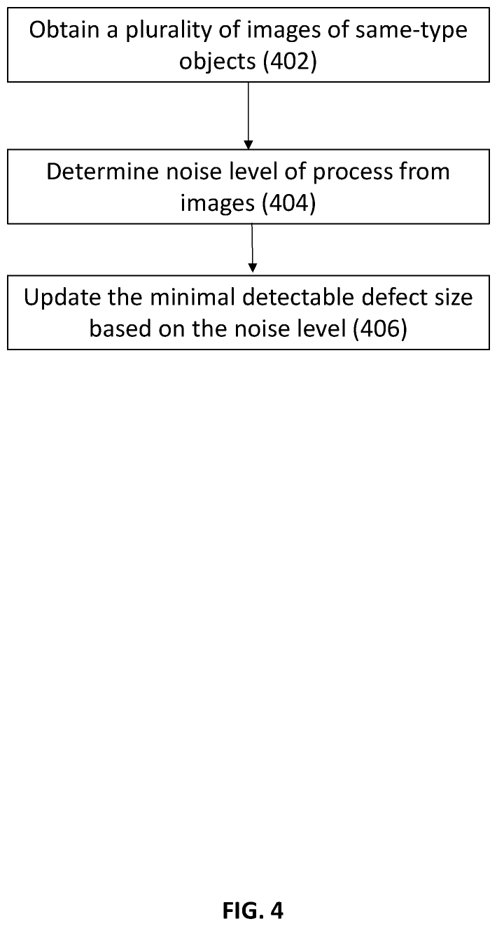

In one embodiment, which is schematically illustrated in FIG. 4, processor 102 obtains a plurality of set up images (402) from which the level of noise of the inspection process may be determined (404). The level of noise may include, for example, relative tolerance levels between same-type items, surface variations and artifacts (that are not defects), etc. The minimal detectable defect size may be updated based on the determined noise level (406). For example, an expected minimal size can be increased if the level of noise is high and decreased if the level of noise is low.

In some cases, different regions of an item may differ in texture, pattern, color, etc., and consequently may show differing levels of noise. Some regions may include moving parts or other features that may contribute to the noise level.

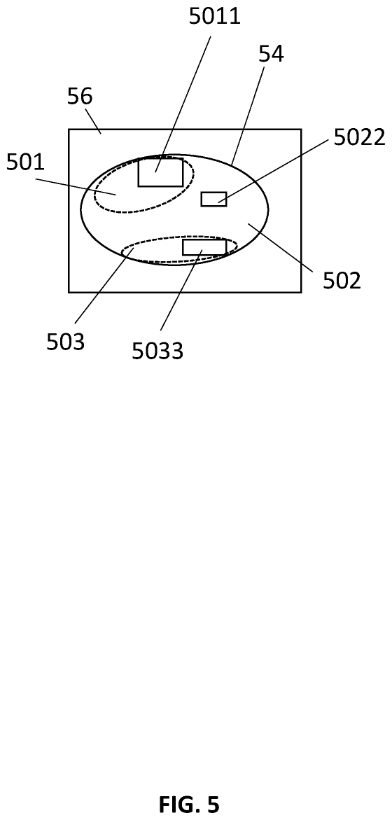

In one embodiment, which is schematically illustrated in FIG. 5, processor 102 determines a plurality of minimal detectable defect sizes, each size for a different region of a single item. In this example, an item 54 in image 56 includes different regions 501, 502 and 503. Region 502 may be relatively similar in all same-type items 54 thus showing a low noise level and a relatively small defect size 5022. Regions 501 and 503 include moving parts or patterns that differ between same-type items 54, thus having larger minimal defect sizes 5011 and 5033, respectively.

Thus, in some embodiments, several minimal detectable defect sizes per item may be presented to a user during a set up stage.

Another example of a parameter that affects inspection results, apart from, or in addition to, the minimal detectable defect size, includes time to detection. ‘Time to detection’ includes the period of time between receiving the image of the item and detecting a defect on the item or performing another inspection task, as detailed above. Detecting a defect may include completing a run of defect detection algorithms on the image of the item and possibly outputting defect information to a user.

This period of time may be affected by several parameters. These parameters, also termed ‘inspection parameters’, are parameters that are adjustable by a user and adjustment of which results in increasing or decreasing the time to detection. For example, the size and/or shape of the item to be inspected may dictate the time required to achieve good registration of set up images, which may be necessary for recognition of the item and for subsequent defect detection. Alternatively or in addition, the size of the specific region, which is associated with defect detection, may affect the time required for defect detection. Ambient illumination conditions may require changing camera and/or illumination parameters, which takes up time. Also, the item and/or camera may have movement induced by the motion of the inspection line or due to moving parts in the item or for other reasons. Typically, complete stillness is required to obtain useful images of items. Thus, the amount of time necessary for the camera and/or item to reach complete stillness may also affect the time to detection. In other cases, a complicated item may require more than one image per item, each image with different focus and/or exposure, in order to obtain images that cover all aspects of the item. One or more of these and possibly other inspection parameters may affect the time to detection.

Some embodiments of the invention provide the user with an initial time to detection. Adjustment of one or more inspection parameters will cause an adjusted time to detection to be calculated and provided to the user. Thus, a user may adjust an initial time to detection by adjusting inspection parameters and may see, in real-time, how his adjustments affect the time to detection. These adjustments typically occur at the beginning of the set up stage. Once the set up stage proceeds, information regarding actual time to detection, e.g., based on the adjusted parameters may be collected and used to calculate an actual time to detection. The actual time to detection may be presented to the user towards the end or at the end of the set up stage.

In one embodiment, processor 102 determines a time to detection based on an image of the item and calculates the expected performance of the system based on the time to detection.

The processor 102 may determine the time to detection based on registration of a plurality of images of an item on an inspection line.

In some embodiments, the processor 102 determines the time to detection based on a size of a specific region of the item, e.g., the region associated with defect detection.

In some embodiments, the processor 102 determines the time to detection based on previous images of same-type items.

Processor 102 may determine the time to detection based on a property of the item in the image. The property of the item in the image may include the size of the item in the image and/or the size of a specific region on the item. The processor may accept, e.g., via the user interface 106, user input relating to the size of the item and/or to the size of the region on the item.

In another embodiment, the property of the item in the image includes motion of at least part of the item in the image. The processor may determine the time to detection based on motion of the item and/or parts of the item and/or based on motion of the camera.

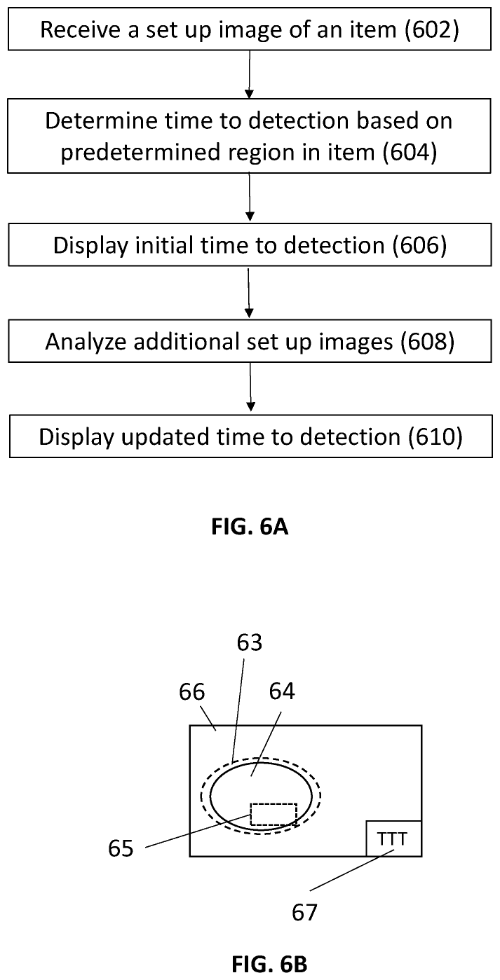

In one embodiment, which is schematically illustrated in FIGS. 6A and 6B, processor 102 receives an image of an item 64 on an inspection line (typically a set up image) (602) and determines an initial time to detection based on a predetermined region of the item in the image (604). The predetermined region may include the entire item as defined by bounding shape 63 and/or specific regions within the item, e.g., as defined by bounding shape 65.

An initial time to detection 67 is then output to a user (606). The image of the item and bounding shapes 63 and 65 superimposed on the item 64 and/or the time to detection may be displayed to a user on display 66. The user may, at this point, adjust inspection parameters, e.g., via display 66 (as described below). Processor 102 may calculate an adjusted time to detection based on the adjusted parameters and may output the adjusted time to the user.

During the set up stage additional images of a same-type item are received and analyzed by processor 102 (608) and an actual time to detection may be calculated based on the analysis of the additional images. The analysis may include, for example, determining the amount of time required by processor 102 to achieve registration of set up images, to enable recognition of the item in a new image.

The actual time to detection can then be presented to the user (610). In addition to displaying the times to detection, information as to how to reduce the time to detection may be displayed on display 66. In one embodiment a message relating to the size of the region on the item, may be output by processor 102 and may be displayed on display 66. For example, the message may include instructions to reduce the region to be inspected. In other embodiments, the message or information may include the amount of time it takes for the item to achieve complete stillness and/or suggestions to enhance or reduce ambient illumination.

A region, which may include the whole item or a specific region of interest (ROI), on the item, may be defined, for example, by a bounding shape, such as a polygon or circular shape, enclosing the imaged item close to the boarders of the item or enclosing the region. The bounding shape may be, for example, a colored line, a broken line or other style of line, or polygon or other shape surrounding the region.

An ROI may be an area on the item which is associated with defect detection. For example, an ROI may be an area on the item in which a user requires defect detection or an area on the item in which the user does not require defect detection. Thus, specific, limited areas may be defined, on which to run detection algorithms, instead of having the algorithm unnecessarily run on a full image. Additionally, same-type items may have variations and artifacts, which are not defects. For example, same-type items may have texture, pattern or color differences or moving parts on the item surface, which are not considered to be defects. These areas of variations may be defined as ROIs in which detection algorithms, such as defect detection algorithms are not applied, thus avoiding false detection of defects.

In some embodiments, an indication of the predetermined region may be input by the user, e.g., by drawing a bounding shape or other indications on display 66. In some embodiments an initial bounding shape is input or indicated by a user and both a user indication and automatic algorithms may be used to create the bounding shape. For example, pixel level segmentation may be used, or automatic segmentation may be used to split the image to different segments and allow the user to choose the segments representing the item. In some embodiments, a user may mark a bounding shape (e.g., on a display 66) and an automatic algorithm then creates a polygon (or other appropriate shape) tightened to the item border closest to the bounding shape input by the user. In other examples, the automatic algorithm may create a polygon (or other appropriate shape) from a user chosen segment.

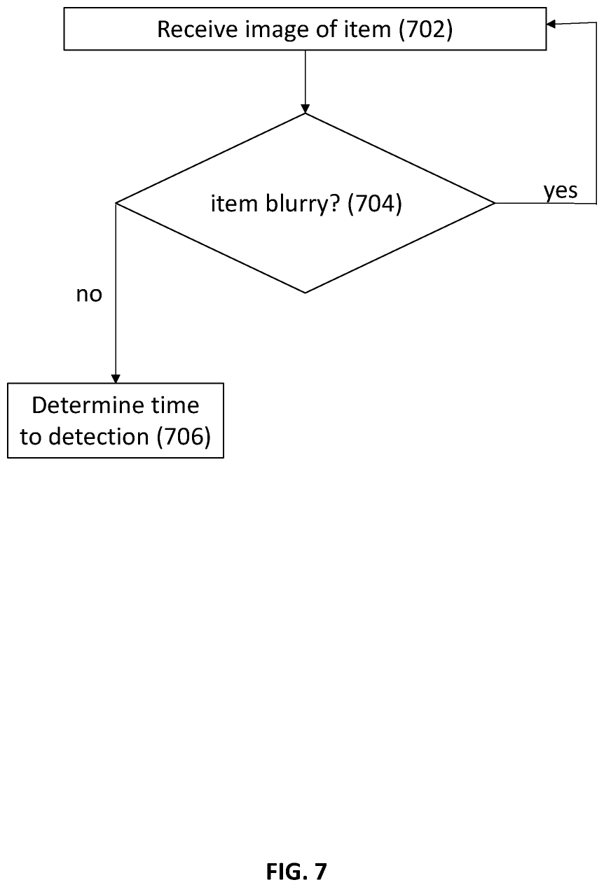

In one embodiment, which is schematically illustrated in FIG. 7, the time to detection is determined based on movement of the item and/or of the camera imaging the item. Processor 102 may receive an image of an item on an inspection line (702), typically a set up image. The image of the item may be blurry due to movement of the item or parts of the item or movement of the camera. In some cases, if the item is a complicated item, e.g., if the item includes a 3D structure, different parts of the item may need different focus of the camera and may thus appear blurry or partly out of focus in the image.

Focus or blurriness may be determined, for example, by checking the position of an item (or parts of an item) between two consecutive images by registering the item between the images or detecting the position of the item (or part of item) in each of a plurality of images to determine if it is in the same position in each of the images, or by performing pixel-level matching between two consecutive images by performing dense techniques such as optical flow, and checking that no pixel shows movement between the two consecutive images.

If the item (or a part of the item) is blurry (704), another image of that item is obtained and checked for blurriness. If movement of the item and/or camera has stopped, the next image may not be blurry. If the item (or part of item) is not blurry (704), detection algorithms (e.g., defect detection) may be run on the image and a time to detection may be determined (706). In this case, the time to detection would include the amount of time required to obtain all the blurry images of the item until a focused image is obtained.

In the case of a complicated item, several images of the same item may be required in order to obtain a useable image of all aspects of the item. The time to detection may be determined based on the number of required images and the time required to obtain each of the images.

As discussed above, an initial time to detection is output to the user, typically, at the beginning of the set up stage. The user may adjust the time to detection by adjusting inspection parameters and may see, in real-time, how his adjustments affect the time to detection.

The initial and/or adjusted times to detection may be calculated based on previously obtained images having previously determined times to detection.

In some embodiments, a database including times to detection measured for same-type or different types of items which were previously inspected, may be maintained, e.g., in storage device 108. Processor 102 may calculate the initial and/or adjusted times to detection by looking up, in the database, times measured for parameters similar to current parameters. For example, a user may draw a bounding shape to define an item in a current image. The bounding shape may cover an area of X initial cm². The time to detection of previously inspected areas of X initial cm² was T initial. T initial is then output to the user as the initial time to detection. The user may reduce the area by drawing the bounding shape tightened to the borders of the item or by defining a smaller area of the item. The reduced area is of X adjusted cm². Calculation of the time to detection T adjusted may be calculated as described above and/or based on previously inspected areas of X adjusted cm². T adjusted can then be displayed to the user as the adjusted time to detection.

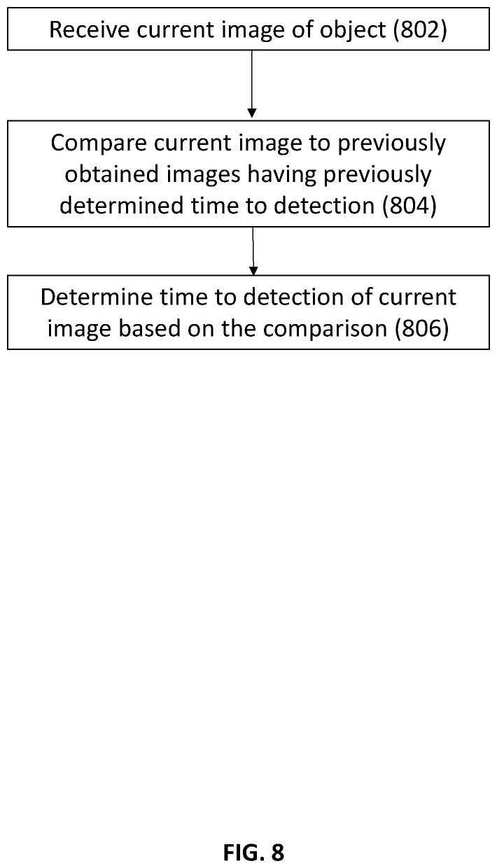

Thus, in one embodiment, which is schematically illustrated in FIG. 8, in initial steps of the set up stage, processor 102 receives a current image of an item on an inspection line (802). The current image is compared to previously obtained images having previously determined time to detection (804) and the time to detection of the current image is determined based on the comparison (806).

The initial and/or adjusted times are typically estimated times. Once the set up stage proceeds, information regarding actual time to detection may be collected and used to calculate an actual time to detection. The actual time to detection may be presented to the user towards the end or at the end of the set up stage.

In some embodiments either one or both of the minimal defect size and time to detection are presented to a user (possibly with instructions on how to improve these parameters) early on during the inspection process. This prior information regarding inspection performance reduces user frustration and can enable the user to improve or adjust the performance to the user or plant's needs. Thus, embodiments of the invention provide improved systems and methods for visual inspection on a production line.

1. (canceled)

2. A visual inspection system comprising:
a processor in communication with a user interface and a camera, the processor to
receive from the camera input, including an image of an item on an inspection line;
determine a time to detection based on the image of the item, the time to detection being a period of time between receiving the image of the item and detecting a defect on the item;
based on the time to detection, calculate, during a set up stage, an expected performance of the system during an inspection stage, which follows the set up stage; and
output, via the user interface, the expected performance.

3. The system of claim 2 wherein the processor is to determine the time to detection based on registration of a plurality of images of an item on the inspection line.

4. The system of claim 2 wherein the processor is to determine the time to detection based on a size of a specific region of the item, the region associated with defect detection.

5. The system of claim 2 wherein the processor is to determine the time to detection based on previous images of a same-type item.

6. A visual inspection system comprising:
a processor in communication with a user interface and a camera, the processor to
receive an image of an item on an inspection line;
determine a time to detection based on the image, the time to detection being a period of time between receiving the image of the item and detecting a defect on the item; and
output, via the user interface, the time to detection.

7. The system of claim 6 wherein the processor is to determine the time to detection based on a property of the item in the image.

8. The system of claim 7 wherein the property of the item in the image comprises a size of the item in the image.

9. The system of claim 7 wherein the property of the item comprises a size of a specific region on the item.

10. The system of claim 7 wherein the property of the item in the image comprises motion of at least part of the item in the image.

11. The system of claim 6 wherein the processor is to update the time to detection based on changes to the camera zoom; and output an updated time to detection.

12. The system of claim 6 wherein the processor is to determine the time to detection based on motion of the camera.

13. The system of claim 6 wherein the processor is to determine the time to detection based on previously determined times to detection corresponding to previous images of a same-type item.

14. A visual inspection method comprising:
receiving an image of an item on an inspection line;
determining an initial time to detection based on a region of the item in the image;
outputting to a user the initial time to detection;
calculating an adjusted time to detection based on adjusted parameters input by the user; and
outputting the adjusted time to the user.

15. The method of claim 14 wherein the region comprises an entire item.

16. The method of claim 14 wherein the region comprises a specific region within the item, the region defined by a bounding shape.

17. The method of claim 14 comprising:
receiving additional images of a same-type item;
calculating an actual time to detection based on analysis of the additional images; and
presenting the actual time to detection to the user.

18. The method of claim 17 wherein analysis of the additional images comprises determining an amount of time required to achieve registration of the additional images, to enable recognition of the item in a new image.

19. The method of claim 14 comprising displaying to the user information as to how to reduce the time to detection.
